(19) United States
(12) Patent Application Publication
(10) Pub. No.: US 2009/0114503 A1
(43) Pub. Date: May 7, 2009

(54) BANKNOTE HANDLING APPARATUS AND AUTOMATIC TELLER MACHINE

(76) Inventors: Tomoyo TAKAI, Owariasahi (JP); Yuji Nagaya, Seto (JP); Genta Ogawa, Seto (JP)

Correspondence Address: MCDERMOTT WILL & EMERY LLP, 600 13TH STREET, N.W., WASHINGTON, DC, 20005-3096, US

(21) Appl. No.: 12/264,542

(22) Filed: Nov. 4, 2008

(30) Foreign Application Priority Data
Nov. 7, 2007 (JP) 2007-289355

(51) Int. Cl. G07F 7/04

(52) U.S. Cl. 194/206

(57) ABSTRACT

A banknote handling apparatus and an automatic teller machine are provided which by no means suffer from the prolonged transaction time resulting from the second discrimination process that must be performed at reduced banknote transfer speeds. The banknote handling apparatus comprises a banknote receipt/payout section for receiving and paying out banknotes; a banknote discriminating section for discriminating false or problematic banknotes from genuine ones; a banknote storage for storing banknotes; a banknote transfer route for transferring banknotes among the sections and the storages; and a main control section for performing control processes, wherein the main control section causes the banknote discriminating section to perform the first banknote discrimination process when the banknote discriminating section discriminates the banknotes which the user paid in the banknote receipt/payout section in the pay-in transaction, and also to perform the second banknote discrimination process at the time other than the pay-in transaction.

### INCORPORATION BY REFERENCE

The present application claims priority from Japanese application JP 2007-289355 filed on Nov. 7, 2007, the content of which is hereby incorporated by reference into this application.

### BACKGROUND OF THE INVENTION

### Field of the Invention

This invention relates to an automatic teller machine which can handle cash, and more particularly to a banknote handling apparatus and an automatic teller machine provided with the function of identifying the users who paid in banknotes into the automatic teller machine.

There have been proposed to date some systems wherein the banknote information on the banknotes discriminated as false or doubtful in the banknote discriminating section is related to the personal information on the users who paid in the false or doubtful banknotes; the related information is stored in the memory device; and the users can be traced later.

Recently, similarity of false banknotes to genuine ones has so advanced as to make it difficult to discriminate banknotes being conveyed at high-speeds as to whether or not they are false, doubtful or genuine.

A method has been proposed in, for example, JP-A-2004-295782, wherein false or doubtful banknotes are identified as such by lowering the speed of banknote transfer.

According to this method disclosed in JP-A-2004-295782, a second discrimination process is additionally performed on the false or doubtful banknotes while they are transferred at reduced speeds. With such a method, therefore, a demerit is incurred that the transaction time is prolonged.

### SUMMARY OF THE INVENTION

The object of this invention, which has been made to eliminate the above mentioned demerit, is to provide a banknote handling apparatus and an automatic teller machine which can prevent the transaction time from being prolonged due to the second discrimination being performed while transferring banknotes at reduced speeds.

This invention is characterize by a banknote handling apparatus comprising a banknote receipt/payout section for receiving and paying out banknotes; a banknote discriminating section for discriminating false or problematic banknotes from genuine ones; banknote storages for storing banknotes; a banknote transfer route for transferring banknotes among the sections and the storages; and a main control section for performing control processes, wherein the main control section causes the banknote discriminating section to perform the first banknote discrimination process when the banknote discriminating section discriminates the banknotes in the pay-in transaction where the user pays banknotes in the banknote receipt/payout section, and also to perform the second banknote discrimination process at the time other than the pay-in transaction.

The second banknote discrimination process may include the discrimination of banknotes in greater detail than the first banknote discrimination process.

Further, the banknote information obtained in the first banknote discrimination process may be used as it is, for the banknote discrimination in the second banknote discrimination process.

According to this invention, therefore, there is provided a banknote handling apparatus and an automatic teller machine which by no means suffer from the prolonged transaction time resulting from the second discrimination process that must be performed at reduced banknote transfer speeds.

Other objects, features and advantages of the invention will become apparent from the following description of the embodiments of the invention taken in conjunction with the accompanying drawings.

### BRIEF DESCRIPTION OF THE DRAWINGS

FIG. 1 shows in side view the structure of a banknote handling apparatus;

FIG. 2 shows in block diagram an automatic teller machine and a banknote handling apparatus;

FIG. 3 shows in perspective view the automatic teller machine proper;

FIG. 4 is an illustrative picture for explaining how banknotes are paid into the banknote receipt/payout section by a user;

FIG. 5 is an illustrative picture for explaining how the received banknotes are put in the banknote storages and the reject storage;

FIG. 6 is an illustrative picture for explaining the second level discrimination process;

FIG. 7 shows a screen display developed in the case where any doubtful banknote is put in the storage;

FIG. 8 is an illustrative picture for explaining where the doubtful banknotes are stored in the storage and the order in which the pieces of banknote information are stored in the memory device 107 of the banknote discriminating section;

FIG. 9 is an illustrative picture for explaining the banknote number display screen displaying the number of banknotes that can be paid out;

FIG. 10 is a flow chart for the procedure executed in the transaction of receiving banknotes by the automatic teller machine;

FIG. 11 is a flow chart for the procedure executed in the operation of the detailed discrimination of banknotes; and

FIG. 12 is a flow chart for the procedure executed in the transaction of paying out banknotes.

### DETAILED DESCRIPTION OF THE EMBODIMENTS

One embodiment of this invention will now be described below in reference to the attached drawings.

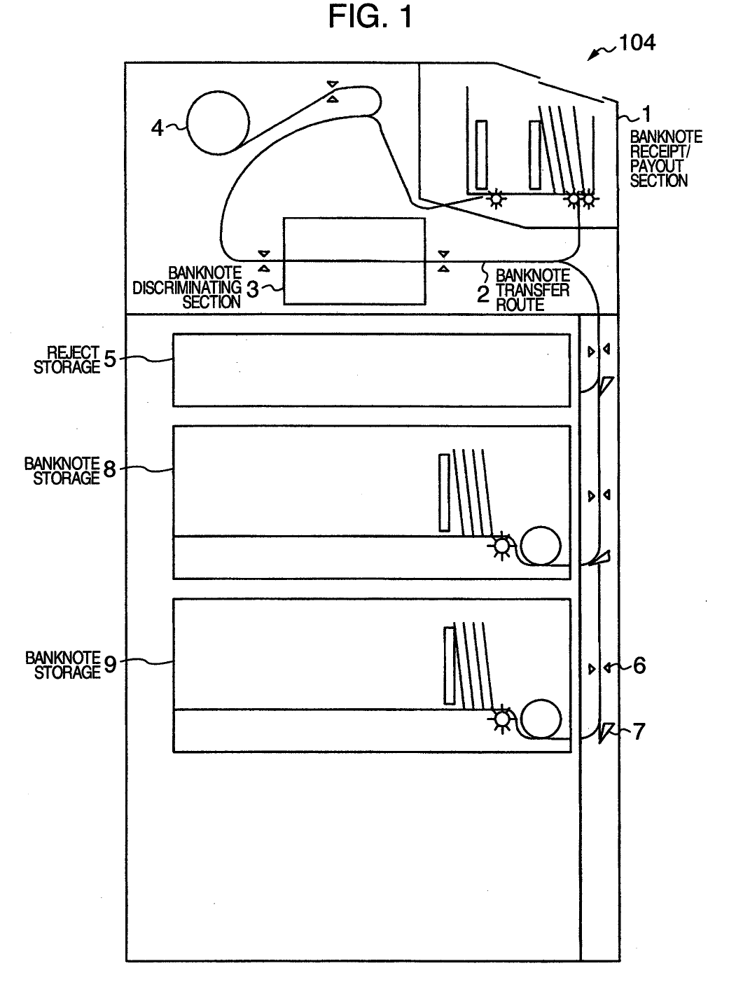

FIG. 1 shows in side view the structure of a banknote handling apparatus 104 according to an embodiment of this invention. In FIG. 1 are shown a banknote receipt/payout section 1; a banknote transfer route 2 through which banknotes are transferred to various sections of the banknote handling apparatus 104; and a banknote discriminating section 3 for discriminating banknotes in species, genuineness, type, and shape, and reading the unique information on each of the banknotes. The unique information on each banknote read by the banknote discriminating section 3 is essential for identifying the particular banknote. In FIG. 1 are also shown a temporary storage 4 for temporarily storing banknotes; a reject storage 5 for storing rejected banknotes during transaction and also serving as a charging/retrieving storage for charging the various storages with banknotes and retrieving banknotes distributed throughout the banknote handling apparatus 104; a banknote transit sensor 6 for detecting the transit of banknotes; a gate 7 for switching the direction of transfer of banknotes, and banknote storages 8 and 9 for storing banknotes.

The summary description of the banknote receiving transaction as one example of banknote handling processes will be described with the banknote handling apparatus 104 as an embodiment of this invention.

When a user inserts banknotes in the banknote receipt/payout section 1 of the banknote handling apparatus 104, the receipt/payout section 1 separates the banknotes and sends out one banknote after another onto the banknote transfer route 2. The banknote discriminating section 3 of the banknote handling apparatus 104 discriminates the species, genuineness and shape of the individual banknote and determines where to store the discriminated banknote.

In the banknote handling apparatus 104, banknotes that are genuine (referred hereafter as genuine banknotes) are stored in the temporary storage 4. In the banknote handling apparatus 104, banknotes that are not genuine or doubtful in genuineness are also stored in the temporary storage 4. The banknote handling apparatus 104 regards those paper moneys whose species are unidentifiable or whose dimensions are abnormal, that cannot be stored in the temporary storage 4, as paper moneys to be rejected and returns them to the banknote receipt/payout section 1 so as to give them back to the user.

The banknote handling apparatus 104 sends out the banknotes, which were temporarily stored in the temporary storage 4, onto the banknote transfer route 2 for the purpose of discriminated storage. The banknote handling apparatus 104 monitors the banknotes transferred on the banknote transfer route 2 by the banknote transit sensor 6 and switches over the gate 7 in accordance with where those banknotes are stored. The banknote handling apparatus 104 stores in the storage 9 those banknotes which were discriminated by the banknote discriminating section 3 as banknotes to be stored in the storage 9, stores in the storage 8 those banknotes which were discriminated by the banknote discriminating section 3 as banknotes to be stored in the storage 8, and stores in the reject storage 5 those banknotes which were discriminated by the banknote discriminating section 3 as banknotes to be rejected.

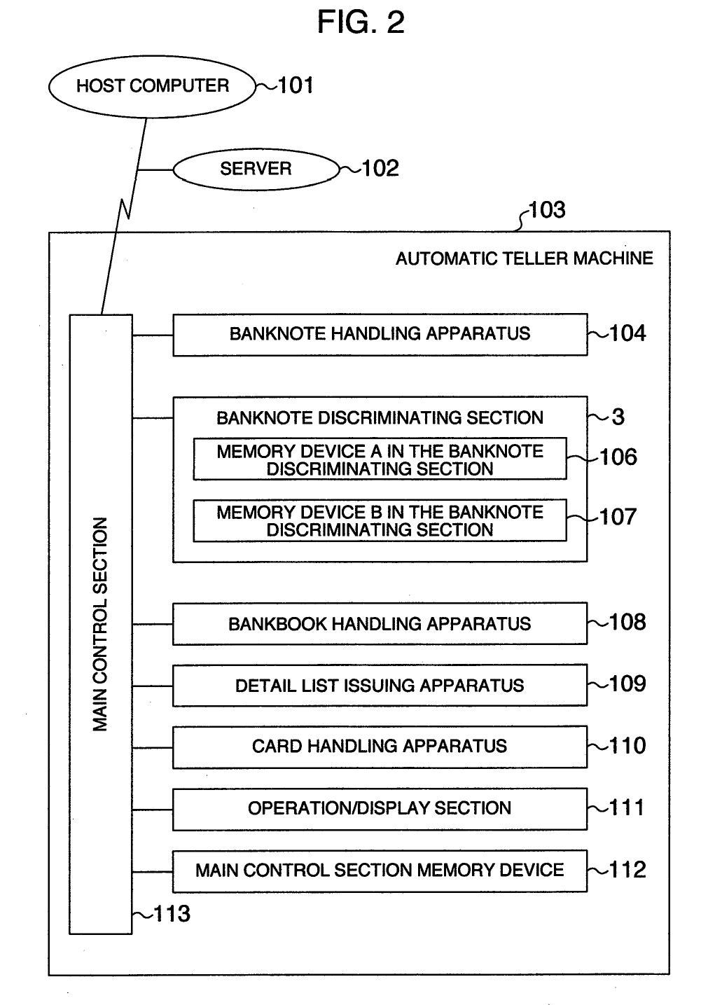

FIG. 2 is a block diagram for the control of a financial system comprising an automatic 103 teller machine and the banknote handling apparatus 104 as described above.

A host computer 101, which serves as an apparatus of higher hierarchy relative to the automatic teller machine 103, receives and transmits the information on transactions. A server 102 has the same function as the host computer 101. The automatic teller machine as a whole is indicated at reference numeral 103.

The banknote handling apparatus 104 controls the transfer of banknotes. The banknote discriminating section 3 discriminates the species, genuineness, type and shape of each banknote and reads the unique information on the banknote. The unique information on each banknote is essential for identifying the particular banknote and may be made up of suitable data such as banknote serial number or characteristic data representative of the outstanding feature of the individual banknote.

Memory devices A and B are provided in the banknote discriminating section 3 and indicated at reference numerals 106 and 107, respectively. The memory devices 106 and 107 store the pictorial information of banknotes, the unique information for identifying each banknote, and the account numbers of users that serve as IDs thereof related to the banknote information. The bankbooks of users are handled by a bankbook handling apparatus 108.

A detail list issuing apparatus 109 issues the detailed listing of transactions. A card handling apparatus 110 handles magnetic stripe cards and IC cards. An operation/display section 111 serves as an input section as well as a display section. The operation/display section 111 accepts the inputs from the touch panel manipulated by a user, clerk in charge and maintainer, and displays the images for manipulation.

A main control section memory device 112 stores programs and needed pieces of information. The main control section memory device 112 stores programs, banknote pictorial and unique information for identifying users, and card data. A main control section 113 performs the overall control of the automatic teller machine 103.

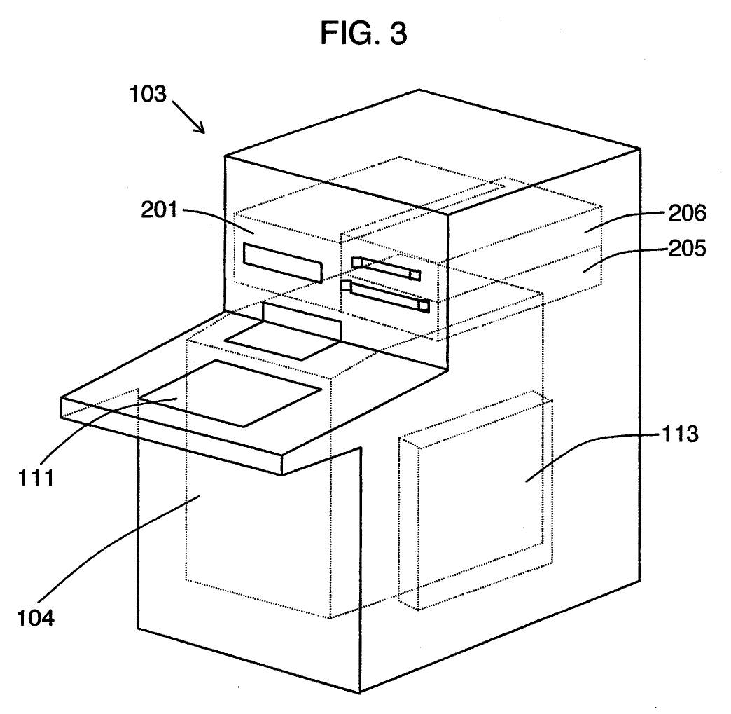

FIG. 3 shows in perspective view the automatic teller machine 103 incorporating therein the banknote handling apparatus 104. The automatic teller machine 103 comprises a bankbook processing mechanism 201 for handling bankbooks, the operation/display section 111 operated by the user, the banknote handling apparatus 104 for receiving and paying out banknotes, a card handling mechanism 205 for handling magnetic stripe cards and IC cards, a detail list issuing mechanism 206 for issuing detailed listings, and the main control section 113 for controlling all of the foregoing constituents. The automatic teller machine 103 is linked to the host computer 101 and the server 102 via communication lines so as to make the reception and transmission of transaction information.

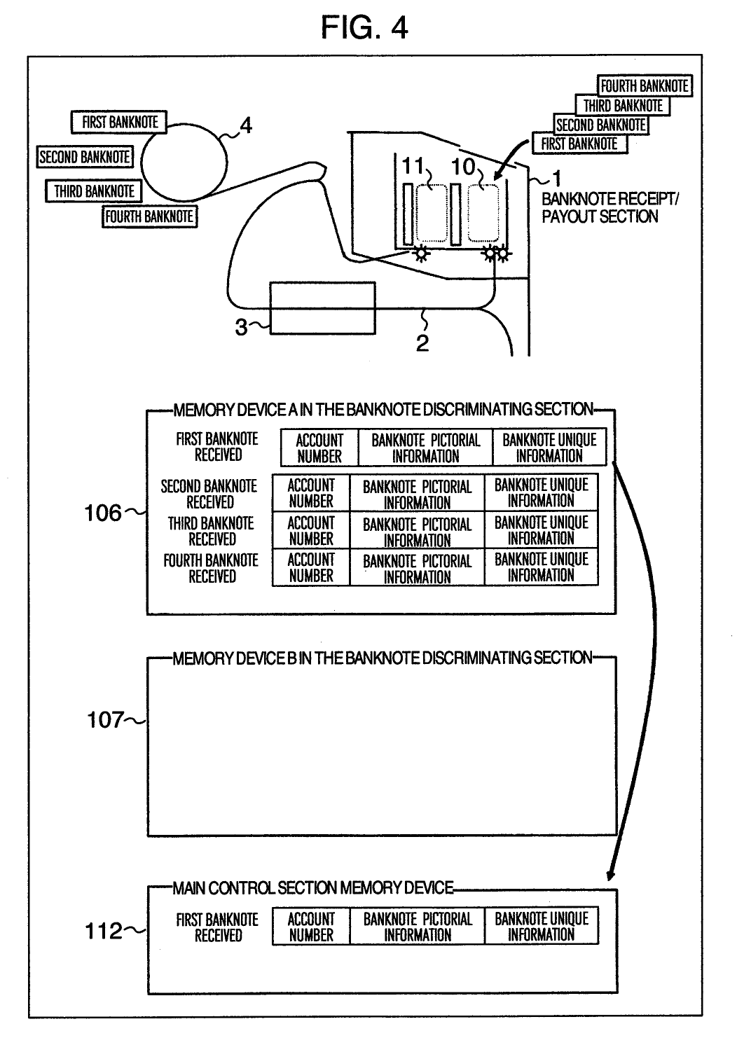

FIG. 4 is an illustrative picture for explaining how banknotes paid into the banknote receipt/payout section 1 by a user, are transferred and how the related information is stored therein.

The banknote receipt/payout section 1 incorporates therein a hopper 10 into which the user throws banknotes, and a reject stacker 11 for storing the returned banknotes that have been identified as banknotes to be rejected by the banknote discriminating section 3.

The automatic teller machine 103 transfers the banknotes thrown into the hopper 10 by the user, to the banknote transfer route 2; the banknotes on the route 2 are then conveyed and passed through the banknote discriminating section 3; and the banknotes having passed through the section 3 are stored in the temporary storage 4. At this time, the banknote discriminating section 3 reads the pictorial information from the individual banknotes that pass through the section 3, and performs the first level discriminating process (i.e. high-speed discriminating process) as the first banknote discriminating process. The first level discriminating process utilizes part of the thus read pictorial information.

The part of the thus read pictorial information refers to the blurred pictorial information (e.g. information whose volume is reduced by lowering the resolution) or the thinned information produced by reducing the volume thereof through any suitable procedure.

The automatic teller machine 103 stores the thus read banknote pictorial information, the account number of the user and the banknote unique information, in the memory device 106 in the banknote discriminating section 3, the memory device 106 serving as the first memory section. The banknote pictorial information and the banknote unique information constitute the banknote information.

The banknote pictorial information is used to discriminate the species, genuineness, type and shape of an individual banknote while the banknote unique information is used to identify the individual banknote. The account number is that which the card handling apparatus 110 has read from the card thrown into the card handling mechanism 205 of the automatic teller machine 103.

Of all the pieces of banknote information stored in the memory device 106, that piece of banknote information which is related to a false or problematic banknote (hereafter referred to as a doubtful banknote) is reported to the main control section 113 by the banknote discriminating section 3 so that the main control section 113 stores the information on the doubtful banknote in the main control section memory device 112. At this time, the section 3 functions as a transmitting means.

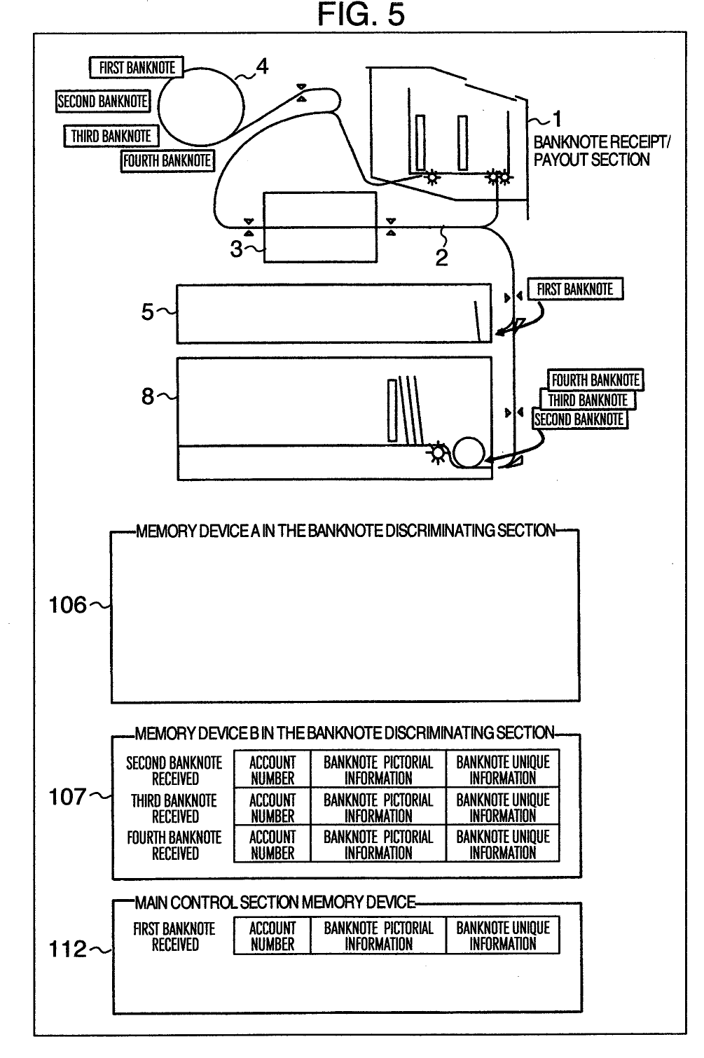

FIG. 5 is an illustrative picture for explaining how the received banknotes are transferred and how the related information is stored, when they are put in the banknote storage 8 and the reject storage 5.

The automatic teller machine 103 sends out banknotes from the temporary storage 4, puts doubtful banknotes in the reject storage 5, and puts the (genuine) banknotes that can be paid out from the next transaction onward in the banknote storage 8. At this time, of all the pieces of information retained in the memory device 106, those pieces of information which are related to the doubtful banknotes and which have been reported to the main control section 113 are deleted. Those pieces of information which have not been reported to the main control section 113, i.e. the information on the banknotes that have been regarded as genuine at the time of reception, are transferred to the memory device 107 in the banknote discriminating section 3. The information on these transferred banknotes is then deleted from the memory device 106 in the banknote discriminating section 3.

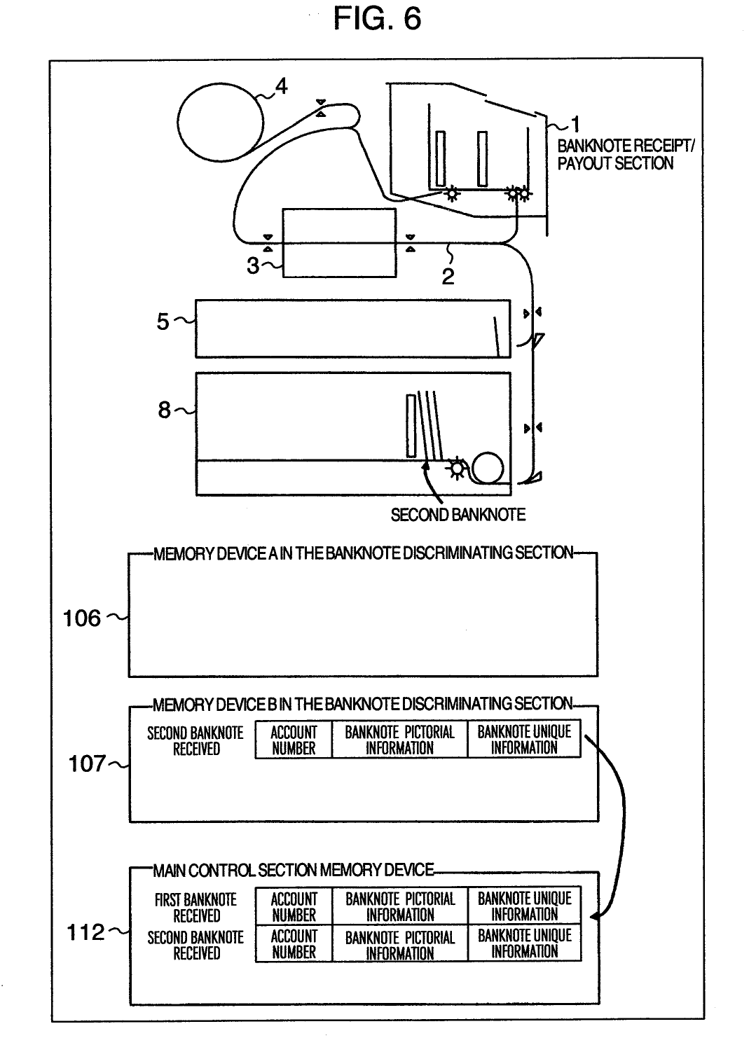

FIG. 6 is an illustrative picture for explaining what kind of information is stored in various memory devices after the second level banknote discrimination process (i.e. detailed discrimination process) has been performed during the standby period by using the banknote pictorial information retained in the memory device 107 of the banknote discriminating section 3.

The automatic teller machine 103 performs the second level discrimination process, i.e. detailed discriminating process, as the second banknote discriminating process by using the information stored in the memory device 107 of the banknote discriminating section 3, as described in reference to FIG. 5. The detailed discriminating process is different from the first level discrimination process performed at the time of the initial banknote reception. This detailed discrimination process takes more time and performs a higher level discrimination through higher calculations, than the first level discrimination process. For example, unlike the first banknote discrimination process where blurring or thinning is used, the second level, i.e. detailed, banknote discrimination process performs a detailed discrimination of banknotes by using the information having more contents than that used in the first banknote discrimination process.

When doubtful banknotes are detected in the detailed discrimination process on the basis of the banknote pictorial information retained in the memory device 107 of the banknote discriminating section 3, the information on the doubtful banknotes is reported to the main control section 113 and stored in the main control section memory device 112.

At this time, the information on the doubtful banknotes detected in the detailed banknote discrimination process is not deleted from the memory device 107, but, on the other hand, the information on the genuine banknotes found in the detailed banknote discrimination process is deleted from the memory device 107.

The detailed banknote discrimination process is set up as a task having lower priority than the transaction process.

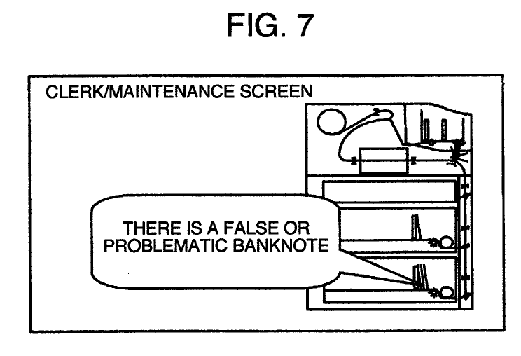

FIG. 7 shows a screen display developed in the case where any doubtful banknote is put in the storage 8 as described in reference to FIG. 6.

The automatic teller machine 103 develops a display of the status that doubtful banknotes are retained in the storage 8, on the clerk screen of the operation/display section 111 so as to tell the clerk in charge or maintainer this status when he/she works on the apparatus 103 (e.g. at the time of starting the running of the apparatus). Thus, the automatic teller machine 103 gives warning against the clerk in charge or maintainer that he/she does not retrieve from the storage 8 the doubtful banknotes together with the genuine banknotes. The clerk screen may be so designed as to display the serial numbers of the doubtful banknotes. In the case where the clerk screen displays the serial numbers of the doubtful banknotes, the clerk can manually remove the doubtful banknotes.

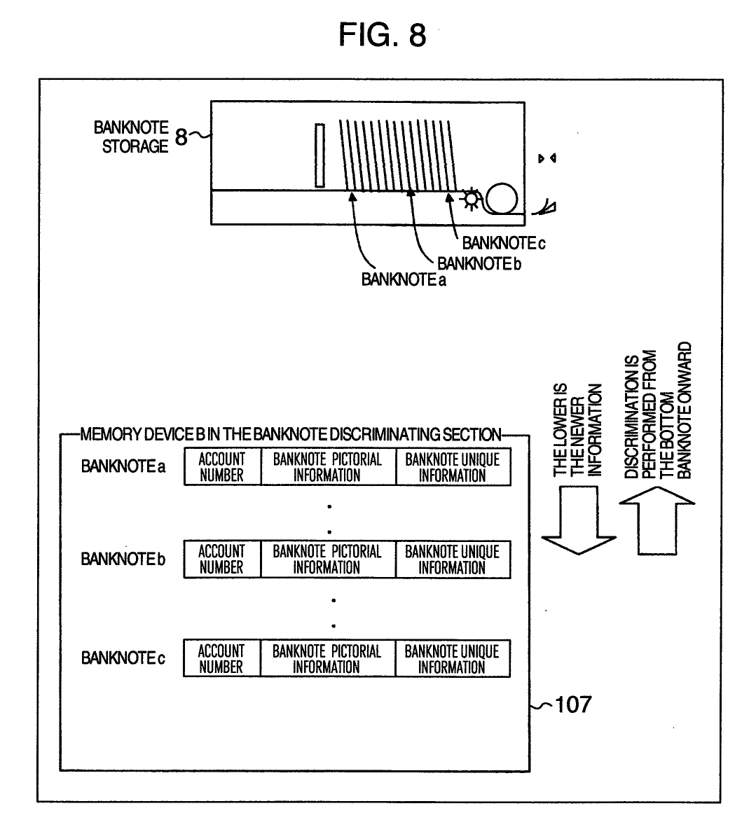

FIG. 8 is an illustrative picture for explaining where the doubtful banknotes are stored in the storage 8 and how the pieces of banknote information are stored in the memory device 107 of the banknote discriminating section 3.

The banknote a was put in the storage 8 at the earliest time and the banknote c was put in the storage 8 at the latest time. Of the pieces of banknote information stored in the memory device 107, the piece of information on the banknote a is the oldest and the piece of information on the banknote c is the newest. Of the banknotes sent out of the storage 8, the banknote c is first sent out, preceding the banknote a. Therefore, the pieces of the banknote information put in the memory device 107 are subjected to the discrimination process in the order reverse to the turn of the banknotes being put in the memory device 107, that is, in the order of LIFO (Last-In First-Out) with the information on the banknote c subjected to the discrimination process first.

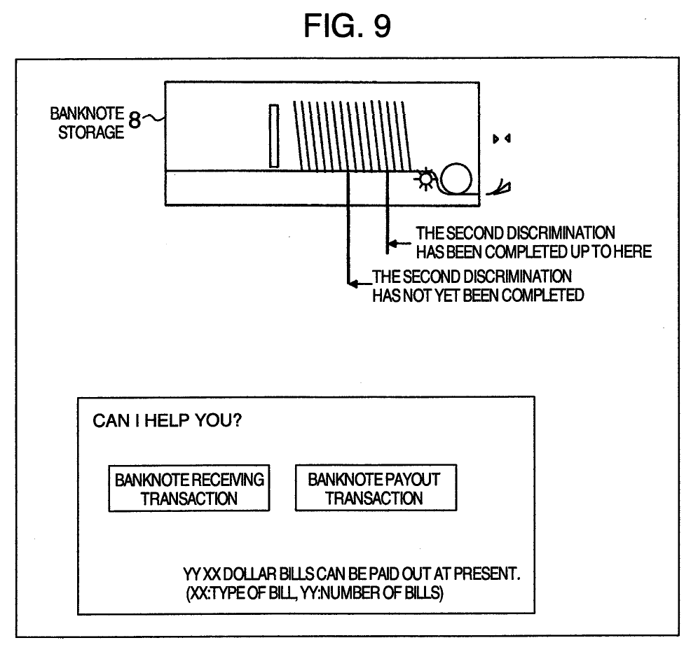

FIG. 9 is an illustrative picture for explaining the banknote number display screen displaying the number of banknotes that can be paid out.

Immediately after banknotes have been put in the storage 8 or 9, no banknotes are ready to be paid out since the banknotes staying at the exit of the storage 8 or 9 have not yet been through the detailed banknote discrimination. As the banknote discriminating section 3 completes the detailed discrimination of each banknote, the section 3 reports the number of payable banknotes to the main control section 113 so that the number of the payable banknotes is displayed at the time of the initiation of transaction. The user will wait until the displayed number of banknotes exceeds that which corresponds to the amount he/she wants to be paid out, or may be paid out within the amount of money limited by the displayed number of banknotes.

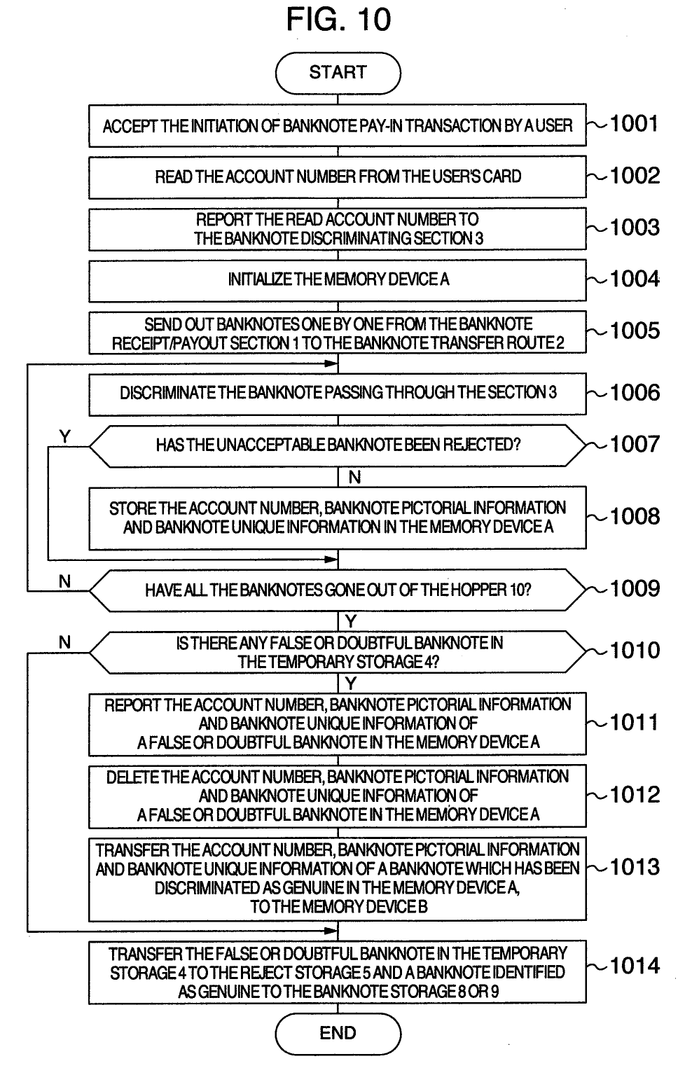

FIG. 10 is a flow chart for the procedure executed in the transaction of receiving banknotes by the automatic teller machine 103.

When the user manipulates the operation/display section 111 to select the banknote receiving transaction, the main control section 113 initiates the transaction of receiving banknotes (Step 1001).

The main control section 113 reads the account number from the user's card by means of the card handling apparatus 110 (Step 1002). Then the main control section 113 reports the read account number to the banknote discriminating section 3 (Step 1003).

The main control section 113 instructs the banknote discriminating section 3 to initialize the memory device 106 that stores banknote information (Step 1004). The main control section 113 then instructs the banknote handling apparatus 104 to transfer the banknotes paid in by the user from the banknote receipt/payout section 1 to the banknote transfer route 2. Accordingly, the banknote handling apparatus 104 transfers the banknotes from the banknote receipt/payout section 1 to the banknote transfer route 2 (Step 1005).

The banknote discriminating section 3 examines the banknote passing through the section 3 along the route 2 under the first level discrimination (Step 1006). The banknote handling apparatus 104 rejects unacceptable banknotes and returns them to the banknote receipt/payout section 1 so that the doubtful banknotes and the genuine banknotes are both put in the temporary storage 4 (Step 1007).

The main control section 113 relates the pictorial and unique information of the doubtful and genuine banknotes to the user's account number and stores the related information in the memory device 106 in the banknote discriminating section 3 (Step 1008).

The main control section 113 repeats the process ranging from Step 1005 through Step 1009 until all the banknotes have gone out of the hopper 10 of the banknote receipt/payout section 1 (Step 1009). When all the banknotes have gone out of the hopper 10, the main control section 113 makes inquiries with the banknote discriminating section 3 about whether or not there were doubtful banknotes (Step 1010).

If the doubtful banknotes and the genuine banknotes are both stored in the temporary storage 4, the main control section 113 receives the report on the account number, pictorial information and unique information related to the doubtful banknotes, all these being stored in the memory device 106, from the banknote discriminating section 3 and stores the reported information in the main control section memory device 112 (Step 1011). At this point of time, the status shown in FIG. 4 is assumed.

The banknote discriminating section 3 deletes the information having been reported to the main control section 113, from the memory device 106 (Step 1012). Then the section 3 transfers the account numbers, pictorial information and unique information related to the genuine banknotes so identified at the time of banknote reception by the automatic teller machine 103 and still remaining in the memory device 106, to the memory device 107 of the banknote discriminating section 3 (Step 1013). At this point of time, the status shown in FIG. 5 is assumed.

The banknote handling apparatus 104 sends out the banknotes stored in the temporary storage 4 onto the banknote transfer route 2, puts the doubtful banknotes into the reject storage 5, and puts the genuine banknotes into the storage 8 or 9 (Step 1014).

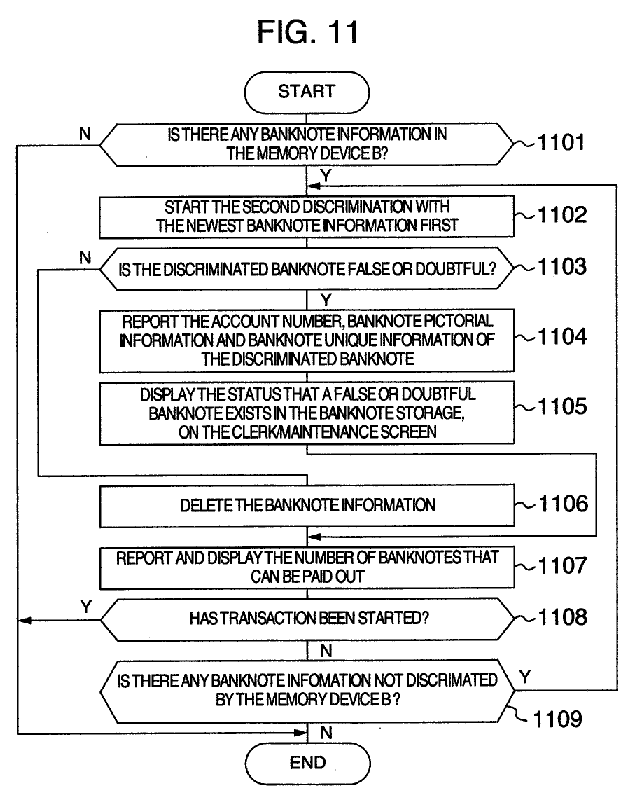

FIG. 11 is a flow chart for the procedure performed in the operation of the detailed discrimination of banknotes.

If there is any banknote information remaining in the memory device 107 in the banknote discriminating section 3 after the user has gone through the pay-in transaction, the section 3 performs the second banknote discrimination by using the related banknote pictorial information (Step 1101). The banknote discrimination performed at this time is the second level, detailed discrimination.

If there are plural pieces of information retained in the memory device 107 of the banknote discriminating section 3, the banknotes related to the plural pieces of information are subjected to the second level, detailed discrimination in the order of LIFO (Step 1102). This detailed discrimination process is applied to those banknotes which have been through the first level discrimination and therefore can be referred to as the second discrimination process.

If there is any banknote which has been discriminated as genuine at the time of receiving transaction but which is discriminated as doubtful in Step 1102 after it has been put in the storage 8 or 9 (Step 1103: Y), then the banknote discriminating section 3 reports the account number and the banknote information such as the pictorial information and unique information related to the banknote identified as doubtful, to the main control section 113. At this point of time, the account number of the user and the related banknote information are stored as the data for following up the user in the main control section memory device 112 (Step 1104).

The user who paid in the doubtful banknote can be identified on the basis of the user's account number and the related banknote information stored in the main control section memory device 112. In such a process of identifying the user who paid in the doubtful banknote, the doubtful banknote may be first specified in reference to the unique information related to the banknote in question and then the user may be identified on the basis of the account number.

The banknote discriminating section 3 instructs the main control section 113 to inform the clerk in charge or maintainer that doubtful banknotes are stored in the storage 8 or 9. Namely, the main control section 113 causes the operation/display section 111 to provide a display indicating that doubtful banknotes are stored in the storage 8 or 9 (Step 1105).

Even after the banknotes identified as genuine have been put in the storage 8 or 9 (Step 1103: N), the banknote discriminating section 3 deletes the information on the genuine banknotes from the memory device 107 thereof (Step 1106). At this point of time, the status shown in FIG. 6 is assumed. The banknote discriminating section 3 reports the completion of the detailed discrimination to the main control section 113 every time an individual banknote goes through the detailed discrimination step. At this time, the main control section 113 renews the display of the number of payable banknotes, developed on the operation/display section 111 operated by the user (Step 1107).

Even in the case where plural banknotes are still stored in the storage 8 or 9 and where the banknote information related to the banknotes which need to be subjected to the detailed (second) discrimination, still remains in the memory device 107 of the banknote discriminating section 3, if the next user initiated a transaction (Step 1108: Y), the detailed discrimination process is interrupted and the transaction is prioritized.

The detailed discrimination process is started with the banknote located nearest to the exit of the storage as described in Step 1102. At the time of paying out banknotes from the storage 8 or 9, it is preferable not to pay out those banknotes which have not gone through detailed discrimination. Therefore, it is possible that every banknote that has not gone through detailed discrimination be paid out as often as it has cleared the detailed discrimination step.

When the transaction has been completed, the process is resumed at Step 1101. As long as the memory device 107 retains any banknote information related to the banknote that has not gone through detailed discrimination, the detailed discrimination process is performed (Step 1109: Y).

When pay-in transactions take place very often, great amount of banknote information is accumulated in the memory device 107 of the banknote discriminating section 3. Accordingly, it is preferable that the memory device 107 is a non-volatile memory having a large capacity.

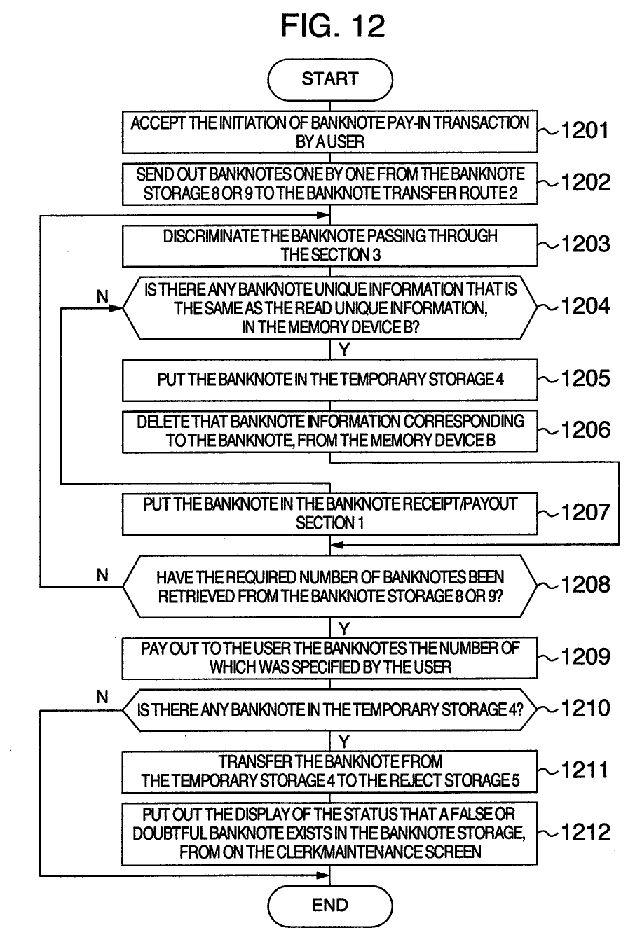

FIG. 12 is a flow chart for the procedure performed in the transaction of paying out banknotes as one example of transaction processes.

The main control section 113 allows the user to manipulate the operation/display section 111 and accepts the initiation of the transaction of paying out banknotes (Step 1201).

The main control section 113 instructs the banknote handling apparatus 104 to send out banknotes, the number of which is specified by the user, from the storage 8 or 9. According to the instruction, the banknote handling apparatus 104 sends out one banknote after another from the storage 8 or 9 (Step 1202).

The banknote discriminating section 3 performs the discrimination of banknotes passing through it and reads the unique information of the banknotes such as the serial numbers and features of the banknotes (Step 1203). Then, the section 3 checks whether or not there are those pieces of unique information in the memory device 107 which are the same as the read unique information (Step 1204).

If there is in the memory device 107 a piece of unique information which is the same as the read unique information, the banknote corresponding to the read unique information is that which was identified as a doubtful banknote in the step of detailed discrimination in the storage. Accordingly, the main control section 113 excludes this banknote from transaction and sends it via the banknote transfer route 2 into the temporary storage 4 (Step 1205).

The main control section 113 deletes the information on the banknotes that no longer exist in the storage, from the memory device 107 (Step 1206). It is preferable at this time to add the pictorial information on the doubtful banknote to the banknote information accumulated to identify the users. Such pictorial information can be used to identify the user who paid in the doubtful banknote.

That banknote which was identified as genuine under the detailed discrimination in the storage will not have its unique information in the memory device 107 of the banknote discriminating section 3. Accordingly, the main control section 113 transfers this banknote to the banknote receipt/payout section 1 via the banknote transfer route 2 (Step 1207).

Step 1203 is repeatedly returned to until the required number of banknotes have been retrieved from the storage 8 or 9 (Step 1208: N). When the required number of banknotes have been retrieved (Step 1208: Y), the banknote handling apparatus 104 pays out from the banknote receipt/payout section 1 to the user the banknotes the number of which was specified by the user (Step 1209).

When there is no longer any banknote in the temporary storage 4 (Step 1210: N), the main control section 113 finishes its process. When there is any banknote in the temporary storage 4 (Step 1210: Y), the main control section 113 transfers the banknote from the temporary storage 4 to the reject storage 5 (Step 1211). The banknote that was in the temporary storage 4 is that banknote which was retrieved from the storage but excluded from transaction.

The main control section 113 deletes the display indicating the existence of doubtful banknote in the storage, from the clerk/maintainer screen on the operation/display section 111 (Step 1212).

According to the configurations and operations as described above, there is provided the automatic teller machine 103 wherein those doubtful banknotes which escaped the discriminative detection during the pay-in transaction are detected out of the banknotes stored in the storage 8 or 9; the banknote information to be used to identify the user who paid in the doubtful banknotes can be additively accumulated; and the doubtful banknotes can be prevented from being paid out in the following transaction to another user who is different from the user who paid in the doubtful banknotes.

Also, according to the configurations and operations as described above, the detailed discrimination process is performed in the idle time during which transactions such as banknote reception and payout are not executed. Accordingly, the first level, high-speed discrimination process can be performed within a short period of time during transactions and the detailed discrimination process can be carried out taking enough time after the transactions. As a result, the two objectives otherwise incompatible, that is, the improvement in the precision in detecting doubtful banknotes and the reduction in time of transaction process, can be made compatible.

Moreover, according to the configurations and operations as described above, since when doubtful banknotes are detected in the detailed discrimination process, the information on the user who paid in the doubtful banknotes (the user's account number in this embodiment) can be obtained along with the banknote information on the doubtful banknotes, then the user who paid in the doubtful banknotes can be identified. Accordingly, the user of such doubtful banknotes can be traced so that suitable measures can be taken.

Further, according to the configurations and operations as described above, while in the first level discrimination process the high-speed discrimination is performed by using part of the acquired detailed banknote information, the second level discrimination process performs the detailed discrimination by using the pictorial information on banknotes that was already acquired in the first level discrimination process, without resorting to physical reading of banknote information again. Accordingly, the time and control for the additional transfer of banknotes through the banknote discriminating section 3 for the purpose of detailed discrimination will be saved, so that the entire transfer control can be simplified and that the time required for re-discrimination (i.e. detailed discrimination) can be shortened.

Furthermore, according to the configurations and operations as described above, since the detailed discrimination process can be realized through arithmetic process alone, the discrimination process can be carried out during the idle time of the automatic teller machine 103 without interfering with the ordinary transactions.

Additionally, according to the configurations and operations as described above, since the detailed discrimination process can be completed during the period of time between the moment of putting banknotes in the storage 8 or 9 and the moment of next sending out banknotes from the storage 8 or 9, it becomes possible to perform such high-level calculations as requires a considerable amount of time that cannot be allocated for the ordinary transaction which requires the high-speed transfer of banknotes. As a result, the doubtful banknotes that escaped the discriminative detection during transactions can be detected.

Besides, according to the configurations and operations as described above, since the unique banknote information on the doubtful banknotes detected in the storage 8 or 9 is memorized, the doubtful banknotes can be identified by examining the unique banknote information by means of the banknote discriminating section 3 after the doubtful banknotes have been sent out of the storage 8 or 9, and by comparing the examined information with the memorized information. Accordingly, once the detailed discrimination is performed on banknotes, doubtful banknotes can be detected and excluded from transactions without performing an additional high-level arithmetic process so that they can be prevented from being paid out to another user who is different from the user who paid in the doubtful banknotes.

Yet further, according to the configurations and operations as described above, when doubtful banknotes are excluded from transactions, the pictorial information on the doubtful banknotes can be added to the information that is under storage to identify users who went through banknote pay-in transactions. In addition, there is no need for preparing a specific mechanism for storing genuine and doubtful banknotes separately after they have been paid in so that the automatic teller machine can be constructed with less complexity and at lower costs.

Still further, according to the configurations and operations as described above, since the banknote discriminating section 3 is so designed as to be provided separately with the memory device 106 used during the transaction process and the memory device 107 used to memorize the information on the doubtful banknotes, the security in information management can be improved.

It is to be understood that this invention is by no means limited to the configurations and operations described above as embodiment, but that other numerous variations or modifications can be devised without departing from the spirit and scope of this invention.

For example, in the embodiment described above, the main control section 113 of the automatic teller machine 103 serves to control both the first and second level discriminating processes. Instead, however, a separate control section may be provided within the banknote handling apparatus 104 and serve to control both the first and second level discriminating processes.

Alternatively, the banknote information on doubtful banknotes and the account numbers of the users who paid in the doubtful banknotes may be transmitted from the main control section 113 to the host computer 101 or the server 102. In such a case, the host computer 101 or the server 102, which is higher in hierarchy as compared with the automatic teller machine 103, can identify the users who paid in the doubtful banknotes.

It should be further understood by those skilled in the art that although the foregoing description has been made on embodiments of the invention, the invention is not limited thereto and various changes and modifications may be made without departing from the spirit of the invention and the scope of the appended claims.

1. A banknote handling apparatus comprising:
a banknote receipt/payout section which receives and pays out a banknote;
a banknote discriminating section which discriminates false or problematic banknotes from genuine banknotes;
a banknote storage which stores the banknote;
a banknote transfer route which transfers the banknote among the banknote receipt/payout section, the banknote discriminating section and the storage; and
a main control section which performs control processes,
wherein the main control section performs:
a first banknote discrimination process when the banknote discriminating section discriminates the banknote in a pay-in process by a user, and
a second banknote discrimination process on the banknote, which is other than the pay-in process.

2. The banknote handling apparatus as claimed in claim 1, further comprising a first memory section which stores banknote information obtained from the banknote for discrimination performed by the banknote discriminating section,
wherein the main control section performs:
a high-speed banknote discrimination by using part of the banknote information in the first banknote discrimination process and;
a detail discrimination, which is in greater detail discrimination than the first banknote discrimination process, by using the banknote information in the second banknote discrimination process.

3. The banknote handling apparatus as claimed in claim 2, further comprising an input section which receives discriminative information capable of identifying users,
wherein the discriminative information received by the input section is related to the banknote information and the related information is stored in the first memory section.

4. The banknote handling apparatus as claimed in claim 3, wherein:
the main control section performs the first banknote discrimination process and stores, into the storage the received banknote which are discriminated as genuine in the first banknote discrimination process, in a pay-in transaction for storing on the banknote received in the banknote receipt/payout section into the storage;
the main control section then performs the second banknote discrimination process by using the banknote information stored in the first memory section; and
the main control section regards banknote information on a banknote which is discriminated as false or problematic as doubtful banknote information and stores the doubtful banknote information, in association with the discriminative information, into a second memory section.

5. The banknote handling apparatus as claimed in claim 4, further comprising a reject storage which stores the banknote which are excluded from a transaction,
wherein the main control section causes the banknote discriminating section to examine whether or not the banknote whose banknote information coincide with the doubtful banknote information is sent out of the banknote storage in the payout transaction where the banknote is sent out from the banknote storage to the banknote receipt/payout section; and the banknote identified as doubtful banknote is transferred into the reject storage to exclude them from the transactions.

6. The banknote handling apparatus as claimed in claim 5, further comprising a transmitting section which associates the doubtful banknote information with the discriminative information when excluding the doubtful banknotes and transmitting the associated information to an apparatus of higher hierarchy.

7. An automatic teller machine comprising:
a banknote handling apparatus as claimed in claim 6; and
an operation/display section which provides a clerk screen used by the user,
wherein the main control section performs a control operation for displaying a status that the doubtful banknote exists in the banknote storage on the clerk screen.

8. The automatic teller machine as claimed in claim 7, wherein the main control section performs a control operation for displaying a serial number of the doubtful banknote in the banknote storage on the clerk screen.

9. The automatic teller machine comprising a banknote handling apparatus as claimed in claim 6, wherein the main control section performs a user identifying process for identifying the user of the doubtful banknote based on the discriminative information and the banknote information.
